(19) United States
(12) Patent Application Publication
(10) Pub. No.: US 2025/0310429 A1
(43) Pub. Date: Oct. 2, 2025

(54) COMMUNICATING PDU SETS IN A WIRELESS COMMUNICATION SYSTEM

(71) Applicant: GOOGLE LLC, Mountain View, CA (US)

(72) Inventor: Ching-Yu Liao, Mountain View, CA (US)

(21) Appl. No.: 18/863,638

(22) PCT Filed: May 8, 2023
(86) PCT No.: PCT/US23/66749

§ 371 Date: Nov. 6, 2024

Related U.S. Application Data
(60) Provisional application No. 63/339,194, filed on May 6, 2022.

(51) Int. Cl. H04L 69/329; H04L 12/14; H04W 28/02

(52) U.S. Cl. CPC H04L 69/329; H04L 12/1407; H04W 28/0268

(57) ABSTRACT

A method for packet data unit (PDU) handling is implemented in a Policy Control Function (PCF) of a core network (CN) and comprises receiving an indication related to handling a PDU set that includes a plurality of PDUs associated with one unit of information generated at an application level; and providing, to a Session Management Function (SMF) of the CN, rules for processing PDUs in accordance with the indication.

### FIELD OF THE DISCLOSURE

This disclosure relates generally to wireless communications and, more particularly, to supporting advanced media services in a 5G system (5GS) support of.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The 3rd Generation Partnership Project (3GPP) recently proposed that a 5G system (5GS) start providing support of advanced media services such as High Data Rate Low Latency (HDRLL) services, augmented reality (AR)/virtual reality (VR)/extended reality (XR) services, and tactile/multi-modality communication services. XR and media services also can be referred to as “XRM services.” Generally speaking, 3GPP proposed to study enhancements of network exposure to support interaction between 5GS and XRM applications as well as enhancements of Quality of Service (QOS) and policy for XR service and media service transmission.

In a current 5GS, a QoS flow represents the finest granularity of QOS differentiation in a PDU Session. The 5G QoS characteristics correspond to a 5G QOS Identifier (5QI). A 5GS treats each packet in a QoS flow according to the same QoS requirements. However, it has been proposed that a Session Management Function (SMF) control a QoS flow and preconfigure or establish the QoS flow via a Protocol Data Unit (PDU) Session Establishment procedure or the PDU Session Modification procedure.

The characteristics of a QoS flow include a QoS profile, which the SMF can provide to the AN (Access Network) via the Access & Mobility Management Function (AMF) over a N2 reference point, or which the AN can preconfigure. The characteristics of a QoS flow further include one or more QoS rule(s) and, optionally, QOS Flow level QoS parameters associated with these QoS rule(s), which the SMF can provide to a user equipment (UE) via the AMF and over the N1 reference point, or which the UE can derive by applying Reflective QoS control. Further, the characteristics of a QoS flow include one or more uplink (UL) and downlink (DL) packet detection rules (PDRs), which the SMF can provide to the User Plane Function (UPF).

However, XRM services can rely on PDU sets, which are groups of packets carrying payload such as a frame, a slice, or a tile for example. More specifically, a PDU set is composed of one or more PDUs carrying the payload of one unit of information generated at the application level (e.g. a frame or video slice for XRM Services), which have the same importance requirement at the application layer. The application layer generally requires all PDUs in a PDU set are needed to process the corresponding unit of information. In some cases, however, the application layer can recover parts of the information unit when some of the PDUs are missing.

The media layer decodes and handles packets in such a PDU set as one whole because the packets within the PDU set have inherent dependency on each other at the media layer. For example, the media layer can decode the frame/video slice only when all, or a certain minimum number, of the packets carrying the frame/video slice are successfully delivered. As another example, a client application can decode a frame within a GOP (Group of Pictures) only after successfully receiving all frames on which the particular frame depends.

Because XRM services generally require a high data rate and low latency, the 5GS QoS framework requires enhancements to support different QoS handling for a PDU set. Without considering such dependencies between the packets within the PDU set, a 5GS may perform a scheduling only with low efficiency. For example, the 5GS may drop some packets but try to deliver other packets of the same PDU set which the client application cannot use, and in thus unnecessarily expend radio resources. Similarly, audio samples, haptics applications, and remote control operations can benefit from the 5GS considering PDU set characteristics. As another example, PDU sets can carry different content, e.g. I/B/P frames, slices/tiles within an I/B/P frame, etc., and thus allows the 5GS to process packets (e.g., PDUs) that belong to less important PDU set(s) differently to more efficiently utilize resources.

Most XRM services stream using Real-time Transport Protocol (RTP) or secure RTP (SRTP) based or HTTP based streaming protocols. For end-to-end encryption, DTLS or TLS further apply to RTP/SRTP or HTTP-based protocols, respectively.

The existing solutions generally rely on traffic (application/packet) detection at a UPF for PDU set identification and classification and are based on matching RTP/SRTP header/payload. These approaches assume that some header information necessary for the identification of PDUs is not encrypted. As a result, these solutions are insufficient for implementations in which header information is encrypted for protection of privacy. Further, because conventional processing techniques at both the radio access network (RAN) and the core network (CN) are packet-based, i.e., require processing individual packets, enhancements are needed to allow a 5GS to receive and process PDU sets, and provide the RAN with the information the RAN requires to schedule radio resources efficiently. For example, it is currently unclear how 5GS should implement security mechanisms for XRM traffic and PDU set handling.

### SUMMARY

An example embodiment of the techniques of this disclosure is a method for packet data unit (PDU) handling. The method is implemented in a Policy Control Function (PCF) of a core network (CN) and comprises receiving an indication related to handling a PDU set that includes a plurality of PDUs associated with one unit of information generated at an application level; and providing, to a Session Management Function (SMF) of the CN, rules for processing PDUs in accordance with the indication.

Another example embodiment of these techniques is a method for packet data unit (PDU) handling. The method is implemented in a Session Management Function (SMF) of a core network (CN) and comprises receiving, from a Policy Control Function (PCF), first rules related to handling of a PDU set; and providing a User Plane Function (UPF) of the CN with second rules for classifying a data packet as belonging to the PDU set, the second rules based on the first rules.

Yet another example embodiment of these techniques is a node in a core network (CN) comprising one or more processors and configured to implement one of the methods above.

### BRIEF DESCRIPTION OF THE DRAWINGS

FIG. 1 is a block diagram of an example wireless communication system in which a user equipment (UE), a radio access network (RAN), and/or a core network (CN) a base station can implement the techniques of this disclosure for processing PDU sets;

FIG. 2 is a block diagram of an example protocol stack according to which the UE of FIG. 1 can communicate with the RAN of FIG. 1;

FIG. 3 is a service-based representation of the 5GS architecture, including the overall non-roaming reference architecture of the policy and charging control framework for the 5GS;

FIG. 4 is a reference-point based representation of the 5GS architecture, including overall non-roaming reference architecture of the policy and charging control framework for the 5GS;

FIG. 5 is a block diagram of an example PDU set which a CN node, a RAN node, or a UE of this disclosure can communicate;

FIG. 6 is a messaging diagram of an example procedure for Packet Flow Detection (PFD) management, in which an Application Function (AF) provides PDU set handling information to a Network Exposure Function (NEF), in an AF request message;

FIG. 7 is a messaging diagram of an example procedure for PFD management in a User Plane Function (UPF), which a Session Management Function (SMF) can use to provide PDU set handling information to the UPF;

FIG. 8 is a messaging diagram of an example procedure for PDU set handling in a CN;

FIG. 9 is a flow diagram of an example method for PDU handling, which can be implemented in a Policy Control Function (PCF) of the CN of FIG. 1; and

FIG. 10 is a flow diagram of an example method for PDU handling, which can be implemented in an SMF of the CN of FIG. 1

### DETAILED DESCRIPTION OF THE DRAWINGS

### Overview

A node in a CN, a RAN, and/or a UE can utilize the techniques of this disclosure to efficiently support advanced media services in a 5GS.

More specifically, these techniques address the security vulnerability of XRM services that Secure Real-time Transport Protocol (SRTP) for XRM services in a 5GS. The security vulnerability is due to the SRTP encrypting the payload of RTP packets but not the RTP extension headers. These extension headers can contain sensitive information such as per-packet sound levels of the media data in the RTP payload (and thus an eavesdropper can determine that a particular conversation between two individuals is in progress, which can result in a breach of privacy). The system of this disclosure addresses the need for a security mechanism to specify how an application server in a trusted or untrusted domain and a 5G network in the operator's trusted domain encrypt RTP header extensions so as to achieve complete encryption of an XRM traffic using RTP/SRTP streaming protocols, when no DTLS/TLS is available or allowed.

Further, when encryption of RTP/SRTP or RTP extended headers is required, an XRM application can use a fully-encapsulating protocol such as DTLS, with its per-packet overhead. Some XRM also can use the Hypertext Transfer Protocol (HTTP) with Transport Layer Security (TLS), or HTTPS, for streaming data. For an XRM traffic that uses HTTPS or SRTP with DTLS or SRTP with encrypted RTP header extension, identifying a PDU set of the XRM traffic based on matching RTP/SRTP header/payload or SRTP extended header is not feasible, as the relevant header/payload information for the identification of PDUs is encrypted. This discussion addresses the lack of feasible solutions for PDU set identification and classification by the 5GS for such fully encrypted XRM traffics using DTLS/TLS.

Still further, the techniques of this disclosure any solutions support bi-directional XRM traffic, i.e., both uplink (UL) and downlink (DL), for PDU set handling in XRM services.

More specifically, the techniques of this disclosure support PDU set handling for an encrypted XRM traffic in a 5GS by addressing the question of how a 5G network can perform PDU set identification and classification for XRM services which may or may not be encrypted (in particular, what PDU set information should be provided to the 5GS, including UE, RAN and/or UPF, and how should such information be communicated? Also, how can a 5GS determine that a certain PDU belongs to a specific PDU set based on the received PDU set information?) Further, these techniques address the question of how the CN and the RAN in a 5G provision QoS based on PDU sets of XRM services in particular, whether and how to enhance the QoS model and policy control for handling PDU Set with integrated packets including the consideration of the importance/dependency information associated with a given PDU set; and should QoS for a PDU Set be provisioned for both uplink and downlink traffic?)

According to one example solution, an SMF provides a UPF, via an N4 interface, with a Packet Detection Rule (PDR) including a rule for PDU set identification and classification (PSICR). Another example solution is PDR enhancement with PDU set handling including IP packet filter set enhancement for security parameters. Another example solution is PDR with Application Identifier associated to PFD (Packet Flow Description) with PDU Set information including PFD enhancement for security parameters. Another example solution includes traffic treatment rules (e.g. PDU Set QoS Enforcement Rule, PS-QER) for a PDU set. Yet another example solution includes detailed procedures for PDU Set QoS provisioning via an AF request, e.g. create/update AF session.

### Example System and Protocol Stack

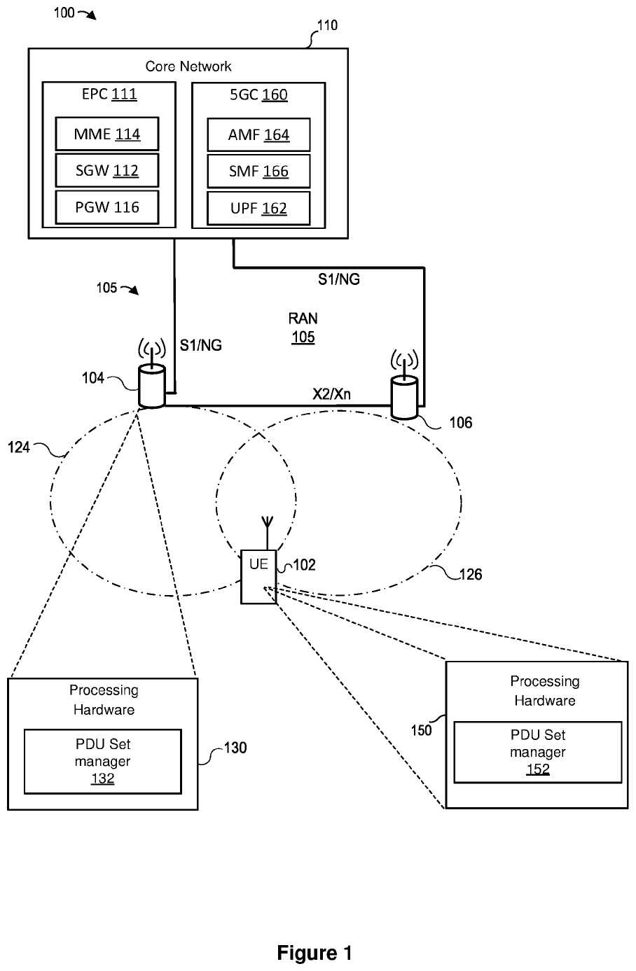

Referring first to FIG. 1, the techniques of this disclosure can be performed by an example wireless communication system 100. The example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. The cells 124 and 126 can partially overlap, so that the UE 102 can select, reselect or hands over from one of the cells 124 and 126 to the other. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

While not shown in FIG. 1, the CN 110 may include processing hardware, which may include one or more general-purpose processors (e.g., CPUs) and a non-transitory computer-readable memory storing instructions that the one or more general-purpose processors execute. Additionally or alternatively, the processing hardware can include special-purpose processing units. The processing hardware may be configured to implement the techniques of this disclosure for enabling 5GS support of advanced media services.

As used in this disclosure, the term “data” or “data packet” may refer to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling mobility management (MM), above the layer of the protocol for controlling session management (SM), or above the layer of the protocol for controlling quality of service (QOS) flows (e.g., service data adaptation protocol (SDAP)). The data to which the UE, CN, and/or the RAN applies the techniques of this disclosure can include for example Internet of things (IoT) data, Ethernet traffic data, Internet traffic data, or a short message service (SMS) message.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a PDU set manager 132.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 130 in an example implementation includes a PDU set manager 152.

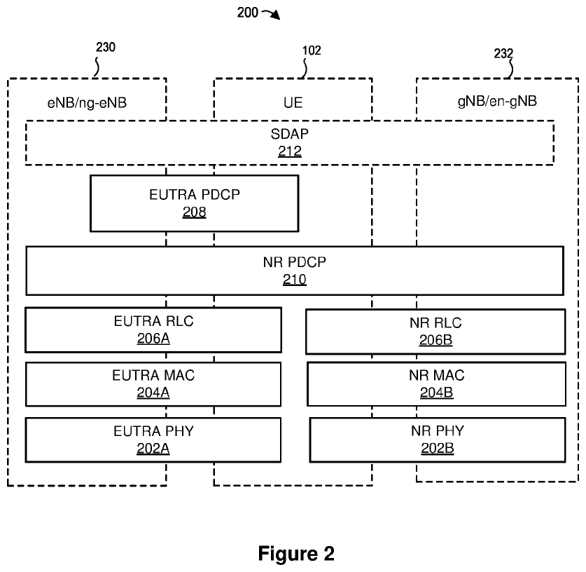

FIG. 2 illustrates, in a simplified manner, an example protocol stack 200 according to which the UE 102 can communicate with an eNB/ng-eNB or a gNB (e.g., one or more of the base stations 104, 106). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

### Example 5GS Reference Architectures

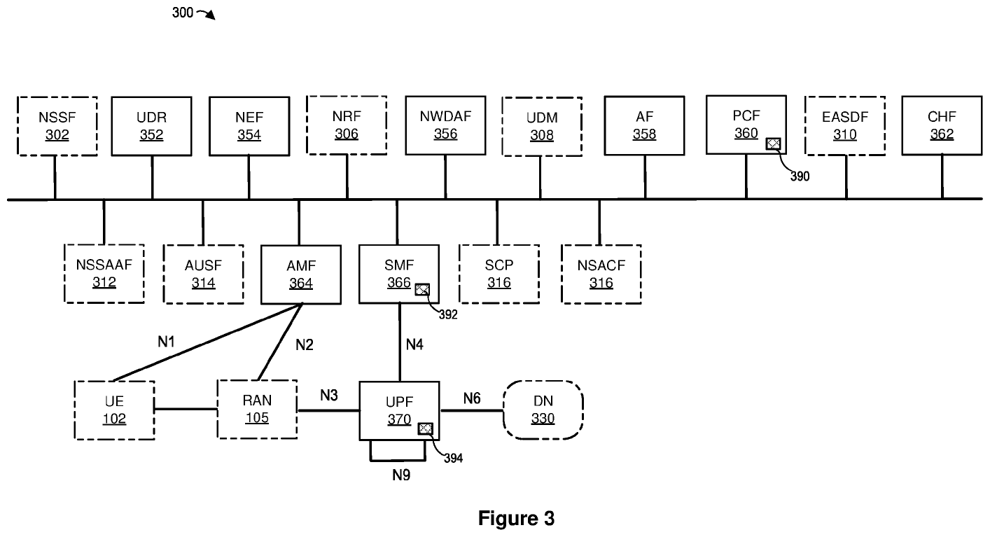

FIG. 3 is a service-based representation 300 of the 5GS architecture. In the representation 300, the overall non-roaming reference architecture of the policy and charging control (PCC) framework for the 5GS includes components illustrated using solid lines, and the other components are illustrated using dashed lines. According to this representation, network functions enable other authorized network functions to access their services. The components that are outside the PCC framework include a Network Slicing Selection Function (NSSF) 302, a Network Repository Function (NRF) 306, a Unified Data Management (UDM) 308, an Edge Application Server Discovery Function (EASDF) 310, a Network Slice Specific Authentication and Authorization Function (NSAAF) 312, an Authentication Server Function (AUSF) 314, a Service Communication Proxy (SCP) 316, and a Network Slice Admission Control Function (NSACF) 316. The non-PCC architecture further includes the UE 102, the RAN 105, and a data network (DN) 330.

The PCC framework in the architecture 300 includes a Unified Data Repository (UDR) 352, a Network Exposure Function (NEF) 354, a network data analytics function (NWDAF) 356, an Application Function (AF) 357, a Policy Control Function (PCF) 360, a Charging Function (CHF) 362, an Access & Mobility Management Function (AMF) 364, a Session Management Function (SMF) 366, and a User Plane Function (UPF) 370.

In an example implementation, the PCF 360 includes a PDU set manager 390, the SMF 366 includes a PDU set manager 392, and the UPF 170 includes a includes a PDU set manager 394.

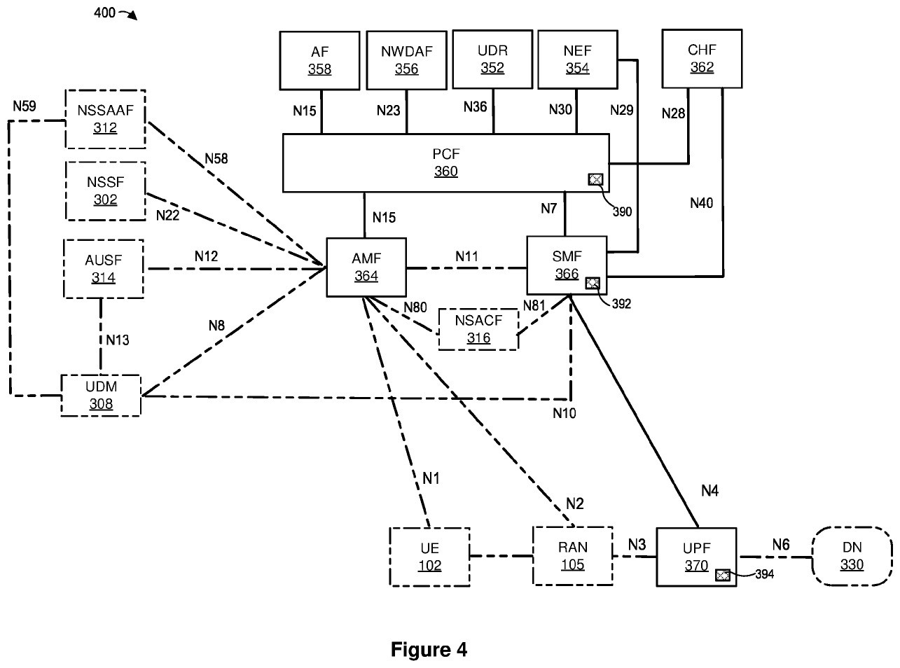

FIG. 4 is a reference-point based representation 400 of the 5GS architecture. In FIG. 4, the non-roaming reference architecture of the PCC framework for the 5GS is illustrated as blocks and connections with solid lines, and components and connections outside the PCC framework are illustrated using dashed lines.

As discussed below, various techniques of this disclosure involve messaging between network functions of the 5GS (e.g., network functions of the CN 110), and between the CN (e.g., the CN 110) of the 5GS, the RAN (e.g., the RAN 105), and the UE (e.g., 102).

### Example PDU Set and QoS Flows

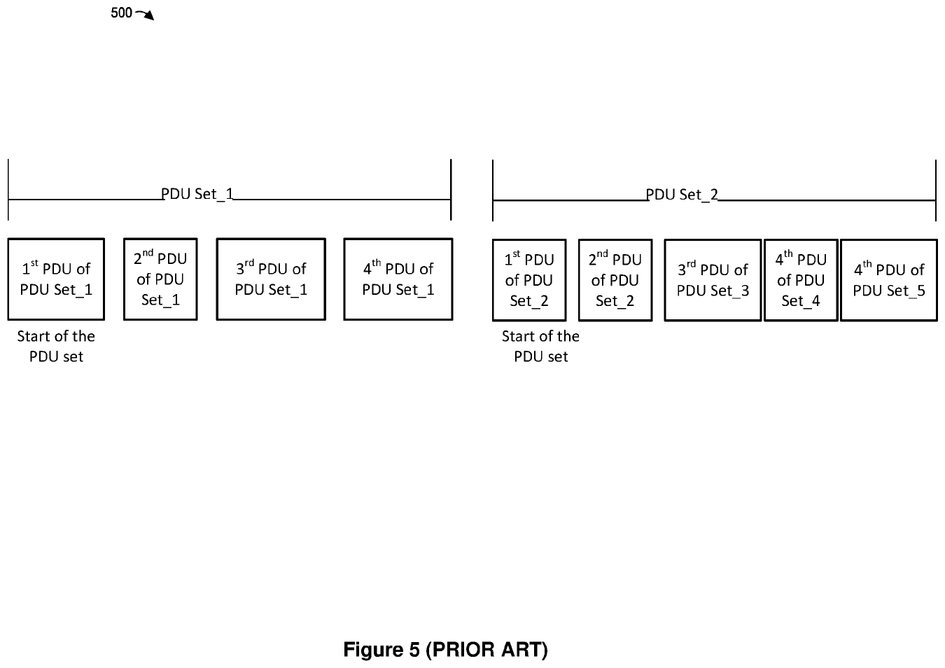

For clarity, FIG. 5 illustrates of an example known PDU set 500 which a CN node, a RAN node, or a UE of FIG. 1 can transmit or receive. According to this approach, a device such as a RAN node, a CN node, or a UE marks the first PDU in each PDU set but does not mark the last PDU in a PDU set.

Regarding QoS flows, a QoS flow in a 5GS is associated with QoS requirements as specified by QoS parameters and QoS characteristics. The QoS flow represents the finest granularity of QoS differentiation in a PDU Session. A QoS Flow ID (QFI) identifies a QoS flow in the 5G System. User-plane traffic with the same QFI within a PDU session receives the same traffic forwarding treatment (e.g. scheduling, admission threshold). The QFI is carried in an encapsulation header on N3 (and N9) i.e. without any changes to the e2e packet header.

Several example solutions that can be implemented in the system of FIG. 1 are discussed next. In general, these techniques can be combined in any suitable manner.

Solution 1. PDR with PSIC Rules (PSICR) for PDU Set Identification and Classification

Generally speaking, the SMF 366 configures the UPF 370 with instructions related to detecting user data traffic that match (or belong to) a PDR. The SMF 366 controls the traffic detection at the UPF 370 by providing detection information for every PDR. The PDR contain information to classify traffic such as PDUs arriving at the UPF 370.

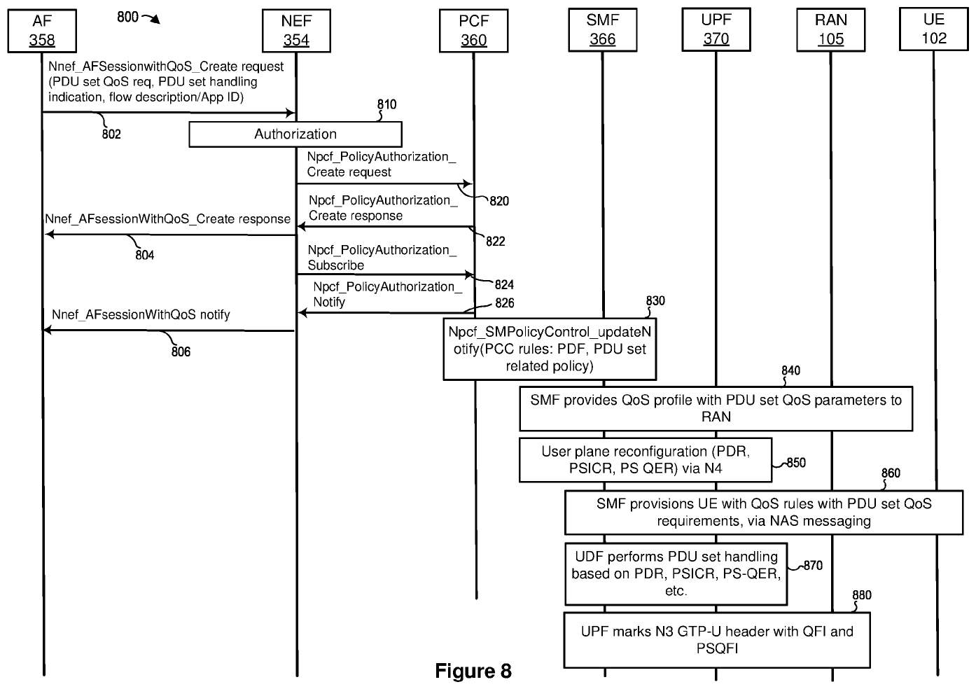

With the PDU Set handling indication and PCC rules enhanced with information for handling PDU Set, the SMF generates PDU Set identification and classification rule (PSICR), which can be used by UPF to identify a packet and then further classify the identified packet to a specific PDU set. Based on the PDR and PSICR, the UPF can further enforce packet treatment rules for the PDU set. The same PDR can be used to handle packets with or without the need of PDU set handling for traffic treatment rules, e.g. QER (QOS enforcement rule), FAR (forwarding action rule), etc. For example, QER can be applied to packets based on associated PDR (TS 23.501 clause 5.8.2.1.1.4). For example, PS-QER (PDU Set QoS Enforcement Rule) can be applied to packets based on associated PDR and PSICR. (PS-QER is detailed in Solution 4.2). Event 850, described below with reference to FIG. 8, includes the SMF configuring the UPF with the PDR and PSICR.

The PSICR can contain the following information (i) N4 Session ID: this provides the associated N4 session; (ii) PDR rules ID: this provides the associated PDR(s); (iii) identification and classification type: indicates the use of RTP/SRTP header or RTP extension header, metadata piggybacked in XRM packets, IP header of TOS/DTRS, or specific IP header configuration for XRM traffic; and (iv) Identification and classification rule: contains information related to packet identification and classification of traffic identified by PDR(s) for a specific N4 session. In particular, (iv-a): if based on RTP/SRTP header or RTP extension header, the rule indicates the specific bits for identification of a PDU for a PDU Set, e.g. M bit indicates a start of a PDU set based on RTP Header; the “S” bit and “E” bit in the Frame Marking RTP header extension respectively represent the start and the end of a video frame. UPF can identify the start and end of a PDU Set/frame according to the “S” and “E” bits; (iv-b): if IP header of TOS/DSCP (Type of Service/Differentiated Services Code Point (DSCP)) or other specific IP header settings is indicated, the rule provides the TOS/DSCP settings or the specific IP header setting for identifying and classifying the packets for PDU Sets; and (iv-c): if metadata piggybacked in XRM packet, the rule indicates how to identify the XRM packet based on metadata, which may be based on RTP/SRTP header or N6 tunnel header info, or IP header information.

### Solution 2. PDR Enhancement for PDU Set Handling

As a further improvement to solution 1, the detection process at the UPF 370 identifies the packets belonging to a session, or a service data flow. Based on TS 23.501, Table 5.8.2.11.3-1: Attributes within Packet Detection Rule (PDR). For IPV4 or IPV6 or IPV4v6 PDU Session type, detection information is a combination of: IP Packet Filter Set (enhancement in Solution 2); CN tunnel info. (Enhancement in Solution 2.1); Application Identifier: The Application Identifier is an index to a set of application detection rules configured in UPF and are associated to Packet Flow Description (PFDs) (enhancement in Solution 3); PDU Set QFI (PSQFI) (enhancement in Technique 4).

Solution 2.1: PDR with IP Packet Filter Set Enhancement for Security Parameter

As a further improvement to solution 2, the IP Packet Filter Set can include a IP PDU Session Type, and the Packet Filter Set can support Packet Filters based on at least any combination of: Source/destination IP address or IPv6 prefix; Source/destination port number; Protocol ID of the protocol above IP/Next header type. Type of Service (TOS) (IPv4)/Traffic class (IPv6) and Mask; Flow Label (IPv6); Security parameter index or Security parameters settings; Packet Filter direction.

The security parameters settings are further extended from security parameter index to enable the following cases: For example, the security parameter contains the information to generate symmetric key or provide asymmetric crypto of public key for encrypting a streaming packet of a specific XRM service (the application server encrypts the packets with private key), which provides completed encryption protection (including packet header and the payload) for the packets of the XRM traffics using RTP/SRTP streaming protocol w/o DLTS. If the XRM traffic is encrypted using HTTPS, i.e. HTTP and TLS, over IP layers as streaming protocols. Additional layer of security protection with symmetric key or public key between the UPF and Application server is optional. For example, if SRTP is used as the streaming protocol, the security parameter contains the same encryption key which is used for the SRTP packet payload encryption to retrieve the metadata piggybacked in the encrypted SRTP payload.

### Solution 2.2

As a further improvement to solution 2.1, based on the PDR with security parameters and PSICR rule with XRM traffic identification/classification type, the UPF handles the packets of the XRM traffic by performing the following steps: trigger PDU Set handling for the received XRM packet from N6/N3; decrypt the XRM packets based on the security parameters indicated in PDR(s); apply corresponding mechanisms indicated in identification/classification type, for PDU set identification, and classification; mark the forwarding packet with PDU Set handling rule, e.g. PDU Set Flow ID (PSQFI).

### Solution 2.3

As a further improvement to solution 2 or 2.1, the UPF can further classify the PDU with PDU set based on additional N6 tunnel information provided in N4 message if available, whereby the N6 tunnel information associates DNN, S-NSSAI, and DNAI which can further provide another level of classification based on target application server location. The DNAI can be differentiated by the application server based on QoS requirements for a specific PDU set. That is, different PDU set is associated to different DNAI within the same DNN and S-NSSAI.

Solution 3. PDR with Application Identifier Associated to PFD with PDU Set Information

As a further improvement to solution 2, the Application Identifier can be associated with information stored in the UDR 352.

### Solution 3.1

Following solution 3, whereby the Application Identifier is associated to PFD (packet flow description) stored in the UDR 352 that is based on the service level agreements between the operator and the Application Server Provider. The PFDs is part of the application detection filters in the SMF/UPF and therefore are used as part of the logic to detect traffic generated by an application. The Application Service Provider (ASP) may remove or modify some or all of the PFDs which have been provided previously for one or more application identifiers. The Application Service Provider (ASP) can provide individual PFDs or the full set of PFDs for each application identifier (App ID) maintained by the ASP to the SMF via the PFD Management service in the NEF (PFDF) and the information is stored at UDR as part of the application related information. There may be different PFD types associated to an application identifier.

A PFD includes the following information: (i) a PFD id; and (ii) one or more of the following: (a) 3-tuple(s) including protocol, server-side IP address and port number; (b) the significant parts of the URL to be matched, e.g., host name; or (c) a Domain name matching criteria and information about applicable protocol(s); (ii) for XRM types of traffic, the following PDU set handling information can be further provided based on the agreement between the AF and mobile operator: (a) identification and classification type: indicates the use of RTP/SRTP header or RTP extension header, metadata piggybacked in XRM packets, IP header of TOS/DTRS, or specific IP header configuration for XRM traffic; (b) Identification and classification rule: contains information related to packet identification and classification of traffic identified by PDR(s) for a specific N4 session: (1) if based on RTP/SRTP header or RTP extension header, the rule indicates the specific bits for identification of a PDU for a PDU Set, e.g. M bit indicates a start of a PDU set based on RTP Header; the “S” bit and “E” bit in the Frame Marking RTP header extension respectively represent the start and the end of a video frame. UPF can identify the start and end of a PDU Set/frame according to the “S” and “E” bits; (2) If IP header of TOS/DSCP (Type of Service/Differentiated Services Code Point (DSCP)) or other specific IP header settings is indicated, the rule provides the TOS/DSCP settings or the specific IP header setting for identifying and classifying the packets for PDU Sets; (3) if metadata piggybacked in XRM packet, the rule indicates how to identify the XRM packet based on metadata, which may be based on RTP/SRTP header or N6 tunnel header info, or IP header information; (c) The security parameters settings are to enable the following cases (1) for example, the security parameter contains the information to generate symmetric key or provide asymmetric crypto of public key for a specific XRM service (the application server encrypts the packets with private key), which provides completed encryption protection (including packet header and the payload) for the packets of the XRM traffics using RTP/SRTP streaming protocol w/o DLTS. If the XRM traffic is encrypted using HTTPS, i.e. HTTP and TLS, over IP layers as streaming protocols. Additional layer of security protection with symmetric key or public key between the UPF and Application server is optional; (2) for example, if SRTP is used as the streaming protocol, the security parameter contains the same encryption key which is used for the SRTP packet payload encryption to retrieve the metadata piggybacked in the encrypted SRTP payload.

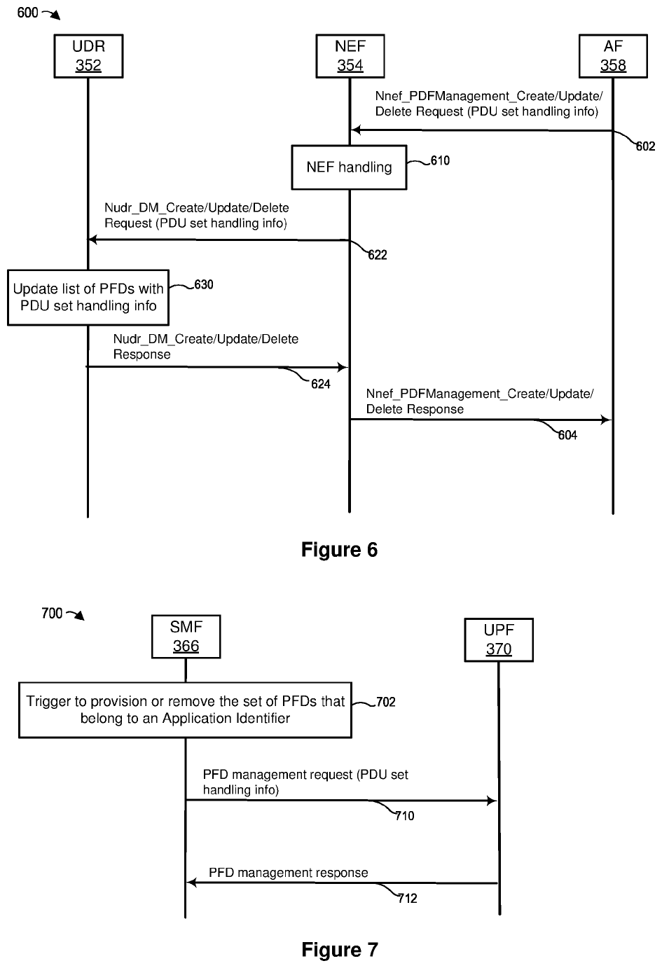

FIG. 6 illustrates a PFD management procedure, which can be enhanced using the techniques of this disclosure, as described below. The information of PDU Set handling for XRM traffics is provided by the PFD management procedure at events 602, 622, and 624. The AF 358 invokes 602 the Nnef_PFDManagement_Create/Update/Delete service. The Allowed Delay is an optional parameter. If the Allowed Delay is included, it indicates that the list of PFDs in this request should be provisioned within the time interval indicated by the Allowed Delay to the SMF(s) that have subscribed to the PFD management service using Nnef_PFDManagement_Subscribe service operation. The PDU Set handling information is provided in the AF request message to the NEF.

Next, the NEF 354 checks 610 whether the AF is authorized to perform this request and NEF (PFDF) checks if the AF is authorized to provision this PFD data based on the operator policies. The NEF (PFDF) 354 invokes 622 the Nudr_DM_Create/Update/Delete (Application Identifier, one or more sets of PFDs, Allowed Delay, PDU Set handling information) to the UDR. The UDR 352 updates 630 the list of PFDs with PDU Set handling information for the Application Identifier. Next, the UDR 352 sends 624 a Nudr_DM_Create/Update/Delete Response to the NEF (PFDF). The NEF 354 sends 604 Nnef_PFDManagement_Create/Update/Delete Response to the AF 358.

Now referring to a scenario 700 of FIG. 7, an N4 procedure used by the SMF 366 to provision or remove all PFD(s) with PDU Set handling information (see event 710) belonging to an Application Identifier in the UPF 370. PFD sets belonging to different Applicant Identifiers can be managed with the same PFD management request message. The N4 PFD management procedure is a node level procedure, i.e., independent of any PDU Session. The SMF 366 is triggered to provision or remove 702 the PFD set belonging to an Application Identifier in the following cases: when the caching timer expires and there's no active PCC rule that refers to the corresponding application identifier, the SMF informs the UPF to remove the PFD(s) identified by the Application Identifier; when a PCC rule is provided for an Application Identifier corresponding to the PFD(s) that are not already provided to the UPF, the SMF shall provide the PFD(s) to the UPF (if there are no PFD(s) cached, the SMF retrieves them from the NEF (PFDF), as described in TS 23.503); when any update of the PFD(s) is received from NEF (PFDF), and there are still active PCC rules in UPF for the Application Identifier. Next, the SMF 366 sends 710 a PFD management request including PDU Set handling information to the UPF to provision/remove the PFD(s) corresponding to the Application Identifier(s). The UPF 370 updates 712 the PFD(s) according to the request and acknowledges by responding with a PFD management response message.

### Traffic Treatment Rules for PDU Set

Further to the solution 1 discussed above, the other parameters can be provided as a set of traffic treatment rules within a PDR with PSICR, which describes how the UPF shall treat a packet that matches the detection information as well as PDU Set identification and classification information, whereby at least one of the following traffic treatment rules in TS 23.501 can be included for the traffic identified by PDR with PSICR: clause 5.8.2.11.4: QOS Enforcement Rule; clause 5.8.2.11.5: Usage Reporting Rule; clause 5.8.2.11.6: Forwarding Action Rule; clause 5.8.2.11.7: Usage Report generated by UPF; clause 5.8.2.11.8: Multi-Access Rule.

### Solution 4.1: For PDU Set QoS Model

As a further enhancement to the solution 4 and 1, based on existing QoS model in TS23.501 clause 5.7, a packet can be further indicated with PDU Set QoS flow ID (PSQFI) which is associated with a set of PDU Set QoS requirements and QOS characteristics, e.g., PDU Set Delay Budget, PDU Set Packet Error Rate, average window, importance level of the PDU set (e.g. with indication for levels of PDU dropping rate), dependency of previous PDU set, dependency of previous PDU within a PDU set, PDU Set Burst size (number of PDUs in a PDU set), PDU Set Burst arrival time at UE (number of PDUs in a PDU set) or UPF (downlink), Periodicity of PDU Set, Survival Time of PDU Set.

The QOS Flow with PSQFI is defined as a PDU Set QoS flow which can be used by the 5G system to provides QoS differentiation for the PDU Set of XRM packets in the PDU Session with the enhancement of the following aspects: a PDU Set QoS Flow ID (PSQFI) is used to identify a QoS Flow with PDU Set in the 5G System; user Plane packet with the same PSQFI within a PDU Session receives the same traffic forwarding treatment (e.g. scheduling, admission threshold); the QFI, PSQFI, or both are carried in an encapsulation header, i.e. GTP-U header, on N3 (and N9) i.e. without any changes to the e2e packet header; the PSQFI shall be unique within a PDU Session; the PSQFI may be dynamically assigned or may be equal to the 3GPP defined PSQI (PDU Set QoS Index).

Any PDU Set QOS Flow can be characterized by: (i) one or more UL and DL PDR(s) with PSICR(s) provided by the SMF to the UPF as described in solution 1; (ii) Aa QoS profile with PDU Set information including PSQFI and PDU Set QoS requirements and QoS characteristics is provided by the SMF to the (R)AN (includes both 3GPP or non-3GPP access network) via the AMF over the N2 reference point or preconfigured in the (R)AN. One or more QoS profiles (without PDU Set information) can additionally be provided by the SMF to the (R)AN as a fallback solution. In such a fallback case, the (R)AN enforces the QoS profile if QoS profiles of the PDU Set are not applicable for implementation causes; (iii) One or more QoS rule(s) of PDU Set and optionally PDU Set QOS Flow level related PDU Set QoS parameters associated with these QoS rule(s) of PDU Set which can be provided by the SMF to the UE via the AMF over the N1 reference point. The QoS rule(s) can be applied to process the corresponding traffic for the UL direction, the DL direction, or both. One or more QoS rule(s) and QoS flow level-related QoS parameters associated with these QoS rule(s) can additionally be provided by the SMF to the UE via the AMF over the N1 reference point and can be applied to process the corresponding traffics for the UL direction, the DL direction, or both. As a fallback solution, a UE enforces QoS rules if QoS rules of PDU Set is not applicable for implementation causes.

### Solution 4.2: PS-QER (PDU Set QoS Enforcement Rule)

Further to the discussion of solution 4 and solution 1, PS-QER includes with the following information: PSQFI; Gate status UL/DL (instructs the UPF to let the PDU Set flow pass or to block the flow); Maximum bitrate of a PDU Set (the uplink/downlink maximum bitrate to be enforced for the packet within a PDU Set); Guaranteed bitrate of a PDU Set (the uplink/downlink guaranteed bitrate authorized for the packets within a PDU Set); Average Window (indicates the time duration over which the Maximum and Guaranteed bitrate of a PDU Set shall be calculated); Down-link flow level marking (Flow level packet within a PDU Set marking in the downlink); Packet rate of a PDU Set (Number of packets in a PDU Set per time interval to be enforced); PDU Set rate (Number of PDU Set per time interval to be enforced).

### AFsession_WithQoS_Create/Update Request Procedures

This solution proposes to enable support of XRM service that allow ASP to request 5GS provisioning required PDU Set QoS requirements to some traffic flows or application of a UE. For example, the procedure in clause 4.15.6.6 of TS 23.502 can be enhanced with the following aspects. The AF request is an AFsessionWithQoS_Create message which includes PDU QOS requirements and a PDU Set handling indication. PDU Set QoS requirements may include one or more of PDU Set Delay Budget, PDU Set Packet Error Rate, average window, PDU Set size (number of PDUs in a PDU set), importance level of the PDU set (e.g. with indication for levels of PDU dropping rate), dependency of previous PDU set, dependency of previous PDU within a PDU set, etc. A PDU Set handling indication contains at least one of the following information: indicates further specific action for the PDU Set handling for XRM traffics, e.g. activation, modification, deactivation; PDU Set Identification and classification type (indicates the use of RTP/SRTP header or RTP extension header, metadata piggybacked in XRM packets, IP header of TOS/DTRS, or specific IP header configuration for XRM traffic); PDU Set Identification and classification rule (contains information related to packet identification and classification of traffic that can be used by SMF as input for generating PDR(s) for a specific N4 session); security parameter (contains the information to generate symmetric key or provide asymmetric crypto of public key for encrypting a streaming packet of a specific XRM service). The NEF or PCF or SMF may retrieve PFD information from UDR based on Application ID or flow descriptions received from AF. Based on the PDU Set handling indication, the PCF generates PCC rules for PDU Set handling, and PDU Set QoS policy to SMF. The SMF further generates a set of rules in N4 message to configure UPF, whereby the rules include PDR and PSICR with a set of traffic treatment rules for handling PDUs in each PDU set. Based on the N4 message, the UPF applies PDR rules and PSICR rules to identify the PDU, classify the PDU into a specific PDU set. The UPF can further configure the N3 GTP header information in the GTP-U packet, which provides PDU set classification information (in band) to RAN.

Referring now to FIG. 8, a scenario 800 involves setting up an AF session with required QoS. In accordance with the techniques of this disclosure, the procedure can be enhanced as follows. The AF 358 sends 802 a request to reserve resources for an AF session using Nnef_AFsessionWithQoS_Create/Update request message (UE address, AF Identifier, Flow description(s) or External Application Identifier, PDU Set Handling Indication, PDU Set QoS requirements, DNN, S-NSSAI) to the NEF. The NEF 354 assigns 810 a Transaction Reference ID to the Nnef_AFsessionWithQoS_Create request. The NEF 354 authorizes the AF request and may apply policies to control the overall amount of QOS authorized for the AF. If the authorisation is not granted, all steps (except event 804) are skipped and the NEF replies to the AF with a Result value indicating that the authorisation failed. The NEF may retrieve PFD information associated to the application identifier indicated in the AF request from UDR.

If the AF 258 is considered to be trusted by the operator, the AF 358 uses 820 the Npcf_PolicyAuthorization_Create request message to interact directly with PCF to request reserving resources for an AF session. If AF request is sent to NEF 354, the NEF 354 determines to directly contact the PCF 360. Alternatively, the NEF 354 may contact a new network function that provides specific services (e.g., to propose required PDU Set QoS parameters based on the PDU Set QoS requirements, flow description or application identifier associated PFD, AF identifier from the AF; to use AUSF services for generating/retrieve security keys based on security parameters. If the NEF 354 determines to contact the PCF directly, the NEF uses the UE address to discover the PCF from the BSF. The NEF 354 interacts with the PCF by triggering a Npcf_PolicyAuthorization_Create request and provides UE address, AF Identifier, Flow description(s) or Application ID, PDU Set QoS requirements and PDU Set handling indication.

For requests received from the NEF 354 (event 820), the PCF 360 determines whether the request is authorized and notifies 822 the NEF if the request is not authorized. If the request is authorized, the PCF derives the required PDU Set QoS parameters based on the information provided by the NEF and determines whether this PDU Set QOS is allowed (according to the PCF configuration), and notifies the result to the NEF. If the AF is considered to be trusted by the operator, the PCF sends the Npcf_PolicyAuthorization_Create response message directly to AF. If the PCF determines that the SMF needs updated policy information, the PCF issues a Npcf_SMPolicyControl_UpdateNotify request with updated policy information about the PDU Session as described in the PCF initiated SM Policy Association Modification procedure in clause 4.16.5.2 in TS 23.502. If the request is not authorized, or the required PDU Set QoS requirements is not allowed, NEF responds to the AF with a Result value indicating the failure cause. If the PCF determines that the SMF needs updated policy information, the PCF issues a Npcf_SMPolicyControl_UpdateNotify request with updated policy information about the PDU Session as described in the PCF initiated SM Policy Association Modification procedure in clause 4.16.5.2.

At event 804, the NEF 354 sends a Nnef_AFsessionWithQoS_Create response message (Transaction Reference ID, Result) to the AF. Result indicates whether the request is granted or not. The NEF 354 sends 824 a Npcf_PolicyAuthorization_Subscribe message to the PCF to subscribe to notifications of Resource allocation status and may subscribe to other events described in clause 6.1.3.18 of TS 23.503. At event 826, when the event condition is met, e.g. that the establishment of the transmission resources corresponding to the PDU Set QoS update succeeded or failed, the PCF sends Npcf_Policy_Authorization_Notify message to the NEF notifying about the event. If the AF is considered to be trusted by the operator, the PCF sends the Npcf_Policy_Authorization_Notify message directly to AF. At event 806, the NEF 354 sends Nnef_AFsessionWithQoS_Notify message with the event reported by the PCF 360 to the AF 358. At event 840, the PCF 360 checks if the PDU Set QoS parameters is corresponds to an authorized PS QoS policy for the AF. If the check is successful, the PCF 360 notifies SMF 366 via Npcf_SMPolicyControl_UpdateNotify message including PCC rules. The PCC rules contain PFD(s), PDU Set QoS policy.

At event 840, a QoS profile with PDU Set information including PSQFI and PDU Set QoS requirements and QoS characteristics is provided by the SMF to the (R)AN (includes both 3GPP or non-3GPP access network) via the AMF over the N2 reference point or preconfigured in the (R)AN. At event 850, based on the PCC rules received from the PCF, the SMF configures the UPF via N4 message including PDR (e.g. traffic classifier policy/application ID based on PFD), PSICR, and PS-QER, etc. At even 860, one or more QoS rule(s) of PDU Set and PDU Set QoS Flow level related PDU Set QoS parameters associated with these QoS rule(s) of PDU Set for the Uplink/Downlink PDU Set handling for required QOS can be provided by the SMF to the UE via the AMF over the N1 reference point. The PDU Set QoS rule(s) can be applied to process the corresponding traffic for the UL direction, the DL direction, or both. Event 850 relates to, for example, solutions 1, 2, and 3 described above. Events 840, 850, and 860 also relate to solution 4.

At event 870, the UPF 370 enforces the configured rules to detect/identify/classify the received packets from N3/N9/N6 interfaces, enforce PDU Set QoS handling based on PS-QER for the identified packet, and mark the classified packet before forwarding the packet. The UPF 370 can further configure 880 the N3 GTP header information, e.g., QFI+PSQFI, in the GTP-U packet, which provides PDU set classification information (in band) to RAN 105.

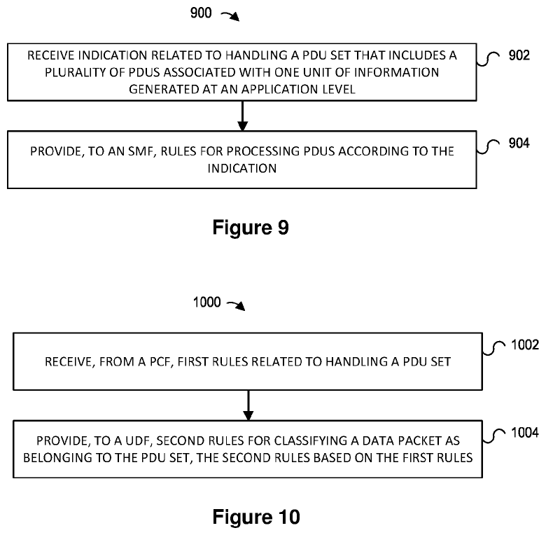

FIG. 9 is a flow diagram 900 of an example method for PDU handling, which can be implemented in a Policy Control Function (PCF) of the CN of FIG. 1. At block 902, the PCF can receive an indication related to handling a PDU set that includes multiple PDUs. At block 904, the PCF can provide, to the SMF, rules for processing PDUs according to the indication.

FIG. 10 is a flow diagram 100 of an example method for PDU handling, which can be implemented in an SMF of the CN of FIG. 1. At block 1002, the SMF receives, from a PCF, rules related to handling a PDU set (e.g., PCC rules). At block 1004, the SMF generates based on the first rules and provides, to a UDF, second rules for classifying a data packet as belonging to a PDU set.

The following list of examples reflects a variety of the embodiments explicitly contemplated by the present disclosure:

Example 1. A method of QOS Provisioning for XR and Media Services in 5GS to enable PDU Set handling for packets traversing through 5G network based on PDU Set QoS requirements and PDU Set Handling Indication provided by an Application Function.

Example 2. The method of example 1, whereby the PDU Set QoS requirement includes: PDU Set Delay Budget, PDU Set Packet Error Rate, average window, importance level of the PDU set (e.g. with indication for levels of PDU dropping rate), dependency of previous PDU set, dependency of previous PDU within a PDU set, PDU Set Burst size (number of PDUs in a PDU set), PDU Set Burst arrival time at UE (number of PDUs in a PDU set) or UPF (downlink), Periodicity of PDU Set, Survival Time of PDU Set.

Example 3. The method of example 2, whereby PDU Set Handling Indication includes at least one of the following information: identification and classification type (indicates the use of RTP/SRTP header or RTP extension header, metadata piggybacked in XRM packets, IP header of TOS/DTRS, or specific IP header configuration for XRM traffic); identification and classification rule (contains information related to packet identification and classification of traffic identified by PDR(s) for a specific N4 session); the security parameters settings are to enable the completed encryption for the XRM packet using a specific streaming protocol, e.g. RTP/SRTP, by generating symmetric key or provide asymmetric crypto of public key for a specific XRM service (the application server encrypts the packets with private key), which provides completed encryption protection.

Example 4. The method of example 3, whereby the AF sends AF request is to request NEF or PCF provisioning required PDU Set QoS requirements to some traffic flows or application of a UE based on PDU Set Handling Indication.

Example 5. The method of example 4, whereby the AF request includes Application ID or flow descriptions.

Example 6. The method of example 5, whereby the AF request is Nnef_AFsessionWithQoS_Create/Update request message or a new message specifically for procedure for handling PDU Set, e.g. Nnef_AFsessionWithPSQoS_Create/Update request.

Example 7. The method of example 6, whereby the PCF generates PCC rules for PDU Set handling, and PDU Set QoS policy to SMF based on the PDU Set handling indication and PDU Set QoS requirements.

Example 8. The method of example 7, whereby the SMF further generates a set of rules in N4 message to configure UPF, in which the rules include PDR and PSICR with a set of traffic treatment rules for handling PDUs in each PDU set.

Example 9. The method of example 8, whereby based on the N4 message, the UPF applies PDR rules and PSICR rules to identify the PDU, classify the PDU into a specific PDU set.

Example 10. The method of example 9, whereby the UPF can further configure the N3 GTP header information, e.g. PSQFI, in the GTP-U packet, which provides PDU set classification information (in band) to RAN.

Example 11. The method of example 10, whereby PSQFI is defined as a PDU Set QoS flow which is used by the 5G system to provide QoS differentiation for the PDU Set of XRM packets in the PDU Session.

Example 12. The method of example 11, whereby a User Plane packet with the same PSQFI within a PDU Session receives the same traffic forwarding treatment (e.g. scheduling, admission threshold).

Example 13. The method of example 12, whereby the QFI, PSQFI, or both are carried in an encapsulation header, i.e. GTP-U header, on N3 (and N9) i.e. without any changes to the e2e packet header.

Example 14. The method of example 13, whereby a PDU Set QoS Flow can be characterized by one or more UL and DL PDR(s) with PSICR(s) provided by the SMF to the UPF.

Example 15. The method of example 14, whereby a QoS profile with PDU Set information including PSQFI and PDU Set QoS requirements and QoS characteristics is provided by the SMF to the (R)AN (includes both 3GPP or non-3GPP access network) via the AMF over the N2 reference point or preconfigured in the (R)AN.

Example 16. The method of example 15, whereby a QoS profile with QFI and QoS requirements and QoS characteristics is provided by the SMF to the (R)AN (includes both 3GPP or non-3GPP access network) via the AMF over the N2 reference point or preconfigured in the (R)AN.

Example 17. The method of example 14, whereby one or more QoS rule(s) of PDU Set and PDU Set QoS Flow level related PDU Set QoS parameters associated with these QoS rule(s) of PDU Set can be provided by the SMF to the UE via the AMF over the N1 reference point and can be applied to process the corresponding traffic for the UL direction, the DL direction, or both.

Example 18. The method of example 17, whereby one or more QoS rule(s) and QoS flow level-related QoS parameters associated with these QoS rule(s) can additionally be provided by the SMF to the UE via the AMF over the N1 reference point and can be applied to process the corresponding traffic for the UL direction, the DL direction, or both.

Example 19. The method of example 18, whereby the UE enforces QOS rules if the QoS rules of PDU Set is not applicable for implementation causes.

The following description may be applied to the description above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for packet data unit (PDU) handling, the method implemented in a Policy Control Function (PCF) of a core network (CN) and comprising:
receiving an indication related to handling a PDU set that includes a plurality of PDUs associated with one unit of information generated at an application level; and
providing, to a Session Management Function (SMF) of the CN, rules for processing PDUs in accordance with the indication.

2. The method of claim 1, further comprising:
receiving quality of service (QOS) requirements for the PDU set.

3. The method of claim 2, further comprising:
providing the SMF with Policy and Charging Control (PCC) rules including a QoS policy for the PDU set.

4. The method of claim 3, wherein:
the providing of the SMF with the PCC rules is in response to determining that QoS parameters based on the QoS requirements correspond to an authorized Packet Switched (PS) QoS policy of an Application Function (AF) of the CN.

5. The method of claim 3, wherein the providing of the SMF with the PCC rules includes:
transmitting a Npcf_SMPolicyControl_UpdateNotify message.

6. The method of claim 2, wherein the QoS requirements include one or more of:
(i) a PDU set delay budget,
(ii) a PDU set packet error rate,
(iii) an average window of a PDU set,
(iv) a PDU set size,
(v) an important level of the PDU set,
(vi) a dependency on a previous PDU set.

7. The method claim 1, wherein:
the indication related to the handling of the PDU set is received from a Network Exposure Function (NEF).

8. The method of claim 1, wherein:
the indication related to the handling of the PDU set is received directly from an AF.

9. The method of claim 7, wherein:
the indication related to the handling of the PDU set is included in a Npcf_PolicyAuthorization_Create request message.

10. The method of claim 1, wherein the indication related to the handling of the PDU set indicates one of:
(i) activation of the PDU set,
(ii) deactivation of the PDU set, or
(iii) modification of the PDU set.

11. The method of claim 1, the indication related to the handling of the PDU set incudes one or more of:
(i) a PDU Set identification and classification type,
(ii) a PDU Set Identification and classification rule, and
(iii) a security parameter of the PDU set.

12. A method for packet data unit (PDU) handling, the method implemented in a Session Management Function (SMF) of a core network (CN) and comprising:
receiving, from a Policy Control Function (PCF), first rules related to handling of a PDU set; and
providing a User Plane Function (UPF) of the CN with second rules for classifying a data packet as belonging to the PDU set, the second rules based on the first rules.

13. The method of claim 12, wherein:
the first rules are Policy and Charging Control (PCC) rules including (i) one or more packet flow descriptors (PFDs) and (ii) a PDU set QoS policy.

14. The method of claim 12, wherein the receiving of the first rules includes:
receiving a Npcf_SMPolicyControl_UpdateNotify message.

15. The method of claim 12, wherein:
the second rules are Packet Detection Rules (PDR) including one or more of:
(i) a traffic classifier policy,
(ii) a PDU set identification and classification (PSICR), or
(iii) a PDU Set QoS Enforcement Rule (PS-QER).

16. The method of claim 12, further comprising:
providing a radio access network (RAN) with a QoS profile including a PDU set information.

17. The method of claim 16, wherein the PDU set information includes at least one of:
(i) PDU Set QoS Flow Identifier (PSQFI),
(ii) PDU Set QoS requirements, or
(iii) PDU Set QoS characteristics.

18. The method of claim 12, further comprising:
providing a user equipment (UE) with one or more QoS rules related to the PDU set.

19. The method of claim 18, further comprising:
providing the UE with PDU set QoS parameters related to a QoS flow and associated with the one or more QoS rules.

20. A Policy Control Function (PCF) of a core network (CN) implemented in a node in a core network (CN), the node comprising one or more processors and configured to:
receive an indication related to handling a PDU set that includes a plurality of PDUs associated with one unit of information generated at an application level; and
provide, to a Session Management Function (SMF) of the CN, rules for processing PDUs in accordance with the indication.
